(19) United States
(12) Patent Application Publication
(10) Pub. No.: US 2003/0217271 A1
(43) Pub. Date: Nov. 20, 2003

(54) Use of smart card technology in the protection of fixed storage entertainment assets

(75) Inventor: Bartley H. Calder, San Jose, CA (US)

Correspondence Address: BEYER WEAVER & THOMAS LLP, P.O. BOX 778, BERKELEY, CA, 94704-0778, US

(73) Assignee: Sun Microsystems, Inc., Palo Alto, CA (US)

(21) Appl. No.: 10/150,139

(22) Filed: May 15, 2002

(51) Int. Cl. G06F 12/14

(52) U.S. Cl. 713/173

(57) ABSTRACT

Methods and apparatus for protecting fixed storage entertainment assets are disclosed. A digital entertainment product stored on a digital media comprises a hub including a smart card storing thereon a certificate or private key and an exterior portion of the digital entertainment product surrounding the hub. The exterior portion stores encrypted digital entertainment content in a read-only format. The smart card is adapted for enabling decryption of the digital entertainment content using the certificate or private key. For instance, when public encryption schemes are desired, the smart card is adapted for accessing a public key and for generating a decryption key from the private key and the public key for decrypting the encrypted digital entertainment content. A player may then use this decryption key for decrypting the encrypted digital entertainment content for presentation to a user.

### BACKGROUND OF THE INVENTION

1. Field of the Invention

The present invention relates generally to computer software. More particularly, the present invention relates to methods and apparatus for implementing smart card technology in the protection of fixed storage entertainment assets.

2. Description of the Related Art

In the entertainment industry, a variety of products are currently distributed on digital media such as Compact Disks (CDs) and DVDs. Common types of entertainment content include digital audio, digital video, computer/video games and other software programs. With the wide distribution of such digital entertainment products, management and protection of digital rights has been difficult to accomplish. More specifically, companies as well as recording artists have realized the importance of protection against unauthorized use or duplication of these digital entertainment products. Unfortunately, a satisfactory mechanism for protecting these assets has yet to be implemented.

There has been a limited amount of success in the achievement of protection of the content stored on digital media. For instance, DVD disks are often encoded with a “region code” which limits their use only to DVD players having a matching region code. The rationale behind this approach is that counterfitters would have to produce separate DVDs for each region. Audio CDs have recently been shipped with “copy protection.” Although the industry has been silent about the details of these copy protection schemes, the result is often to prevent audio CDs from being played on computer CD ROM drives, where a majority of the piracy occurs. These schemes often include random data to confuse CD ROM drives, or encode the music to appear to be another form of data. Often, encryption is used to provide an added layer of security with information such as data transmissions and electronic emails. Unfortunately, the the storage media currently in use with digital entertainment products do not allow the storage of the additional data for use in an encryption or decryption mechanism nor possess the ability to perform cryptographic operations.

In view of the above, it would be desirable to implement a mechanism for protecting digital assets for use with an encryption mechanism.

### SUMMARY

Methods and apparatus for protecting fixed storage entertainment assets are disclosed. This is accomplished, in part, through the incorporation of a smart card chip into a digital entertainment product. Through the storage of a certificate or key on the smart card, the smart card provides security for digital entertainment content stored in an encrypted, read-only format on a digital medium.

In accordance with one aspect of the invention, a digital entertainment product stored on a digital media such as a CD or DVD comprises a hub including a smart card storing thereon a private key and an exterior portion of the digital entertainment product surrounding the hub. The exterior portion stores encrypted digital entertainment content (e.g., movie, music) in a read-only format. The smart card may then be utilized in the decryption of the digital entertainment content.

In one embodiment, public key encryption is used. Typically, a public key certificate is a digitally signed document that serves to validate the sender's authorization and name. The document consists of a specially formatted block of data that contains the name of the certificate holder (which may be either a user or a system name) and the holder's public key, as well as the digital signature of a certification authority for authentication. The certification authority attests that the sender's name is the one associated with the public key in the document. A user ID packet, containing the sender's unique identifier, is sent after the certificate packet. There are different types of public key certificates for different functions, such as authorization for a specific action or delegation of authority. Public key certificates are part of a public key infrastructure that deals with digitally signed documents. The other components are public key encryption, trusted third parties (such as the certification authority), and mechanisms for certificate publication and issuing Thus, the smart card is adapted for accessing a public key and for generating a decryption key from the private key and the public key for decrypting the encrypted digital entertainment content.

When public key encryption is desired, the public key may be stored on the digital entertainment product as well as external to the digital, entertainment product (e.g., on a server). For instance, in accordance with one embodiment, the public key and it's associated certificate are stored in a readable fashion along with the entertainment content, while the private key is stored on the smart card. When the disk is accessed, the public key and identifying certificate are read from the disk and passed to the smart card which generates the decryption key which is used for decrypting the encrypted digital entertainment content.

In accordance with another aspect of the invention, methods and apparatus for processing information stored on a digital entertainment product stored on a digital media are disclosed. A digital entertainment product having a hub and an exterior portion surrounding the hub is received by a device such as a CD or DVD player. As described above, the hub may include a smart card storing thereon a private key, while the exterior portion stores encrypted digital entertainment content in a read-only format. The digital entertainment content may then be decrypted. For instance, if a public encryption scheme is desired, a decryption key generated from a private key from the smart card and a public key is obtained (e.g., by the player). The player then decrypts the encrypted digital entertainment content using the decryption key. The player may then use this decryption key for decrypting the encrypted digital entertainment content for presentation to a user.

Various player and smart card devices may be configured or adapted for implementing the disclosed functionality. These devices include, but are not limited to, CD players and DVD players in combination with contactless smart card technology. (Contactless smart cards allow a device to communicate with a smart card without requirement of a physical connection. Contactless smart cards use a radio link for this communication) Moreover, the functionality for the above-mentioned processes may be implemented in software as well as hardware.

Yet another aspect of the invention pertains to computer program products including machine-readable media on which are provided program instructions for implementing the methods and techniques described above, in whole or in part. Any of the methods of this invention may be represented, in whole or in part, as program instructions that can be provided on such machine-readable media. In addition, the invention pertains to various combinations and arrangements of data generated and/or used as described herein.

These and other features of the present invention will be described in more detail below in the detailed description of the invention and in conjunction with the following figures.

### BRIEF DESCRIPTION OF THE DRAWINGS

The invention, together with further advantages thereof, may best be understood by reference to the following description taken in conjunction with the accompanying drawings in which:

FIG. 1 is a diagram illustrating an exemplary digital entertainment product including a smart card chip in accordance with various embodiments of the invention.

FIG. 2 is a diagram illustrating a local embodiment in which a digital entertainment product player including a smart card reader communicates with the smart card chip of a digital entertainment product in accordance with various embodiments of the invention.

FIG. 3 is a diagram illustrating a client-server embodiment in which an external server provides information such as a public key to enable the entertainment content stored on the digital entertainment product to be decrypted in accordance with various embodiments of the invention.

FIG. 4 is a process flow diagram illustrating a method of decrypting digital entertainment content using a public key stored on the digital entertainment product in accordance with various embodiments of the invention.

FIG. 5 is a process flow diagram illustrating a method of decrypting digital entertainment content using a public key or password obtained from a source external to the digital entertainment product in accordance with various embodiments of the invention.

FIG. 6 is a process flow diagram illustrating a method of tracking a number of times the content can be played in accordance with various embodiments of the invention.

FIG. 7 is a block diagram illustrating a typical, general-purpose computer system suitable for implementing the present invention.

### DETAILED DESCRIPTION OF THE PREFERRED EMBODIMENTS

In the following description, numerous specific details are set forth in order to provide a thorough understanding of the present invention. It will be apparent, however, to one skilled in the art, that the present invention may be practiced without some or all of these specific details. In other instances, well known process steps have not been described in detail in order not to unnecessarily obscure the present invention.

The present invention enables digital entertainment products stored on digital media such as CDs and DVDs to be protected using an embedded smart card. In the following description, the term “smart card” will be used to refer to a smart card or smart card chip. More specifically, the smart card or smart card chip may be manufactured according to ISO 7816. In addition, communication with the smart card may be performed according to ISO 7816. These specifications are incorporated herein by reference for all purposes.

Numerous technologies and strategies are available for protecting digital data. For instance encryption is often used to securely store and transmit data. Typically, the digital data is stored separately from each digital key or certificate used for decryption of the data. The present invention enables encryption to be used to protect digital data through the incorporation of smart card technology in digital entertainment products. Smart cards provide a secure storage mechanism and are used in a variety of industries to provide secure storage of certificates or keys as well as the secure processing of cryptographic algorithms. Moreover, smart cards are physically tamper proof and offer a high level of security.

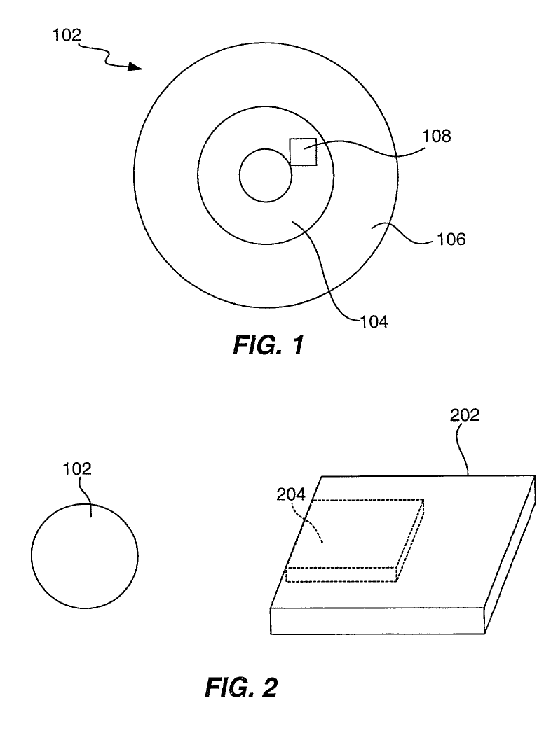

FIG. 1 is a diagram illustrating an exemplary digital entertainment product including a smart card chip in accordance with various embodiments of the invention. A digital entertainment product 102 stored on a digital media includes a hub 104 and an exterior portion 106 of the digital entertainment product 102 surrounding the hub 104. The hub 104 typically does not store data or other information. However, in accordance with various embodiments of the invention, the hub 104 includes a smart card 108 storing thereon a private key. Typically, the exterior portion 106 of a digital entertainment product does not store encrypted data. However, in accordance with various embodiments of the invention, the exterior portion 106 stores encrypted digital entertainment content in a read-only format. The smart card 108 is adapted for accessing a public key and for generating a decryption key from the private key and the public key for decrypting the encrypted digital entertainment content. For instance, the decryption key, once generated, may be provided to a CD or DVD player to enable decryption of the encrypted digital entertainment content. The entertainment content may include audio content and/or video content. For instance, the entertainment content may include music, movies, or computer games.

Some video and audio encoding formats such as MPEG achieve high degrees of compression through segmenting the video or audio content into I-frames, which are displayed at certain frame intervals. Between the I-frames, differences between the frames (e.g., in the form of B or P frames) is sent. In other words, when an I-frame is sent, as the video progresses, the differences between the frames are sent, and at some interval a new I-frame is sent. The I-frame, therefore, “refreshes” the image.

In one embodiment, a method of encryption comprises encrypting the I-frames, while not encrypting the B or P frames. A private key algorithm may be used to encrypt the I-frames. Decryption mechanism and storage of the public key is preferably stored on the smart card. A player would then send each I-frame to the smart card for decryption. Decrypted I-frames would then be sent back to the player to be displayed.

In accordance with various embodiments of the invention, it may be desirable to encrypt a portion of the digital entertainment content rather than all of the digital entertainment content. For instance, it may be desirable to enable a portion of the content to be played to enable a user to determine whether they wish to play the remainder of the content. This may be desirable in a system that requires a password or public key to be obtained (e.g., upon receipt of payment) from the Internet or a phone system for decryption of digital entertainment content that is stored on a digital entertainment product.

In accordance with one embodiment, the smart card 108 is a contactless smart card. While the private key is stored on the smart card 108, the public key need not be stored on the smart card 108. For instance, rather than being stored on the smart card, the public key may be stored on the exterior portion 106 of the digital entertainment product or on a server to be accessed via the Internet.

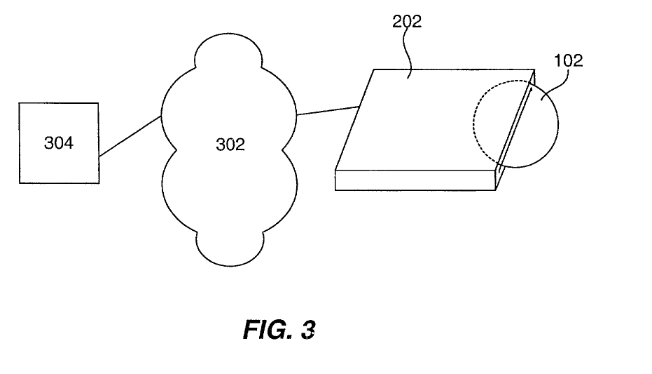

FIG. 2 is a diagram illustrating a local embodiment in which a digital entertainment product player 202 including a smart card reader 204 communicates with the smart card chip of a digital entertainment product in accordance with various embodiments of the invention. More specifically, the digital entertainment product player (e.g., CD and/or DVD player) may include a contactless smart card reader. Thus, the smart card reader 204 is adapted for receiving the digital entertainment product 102. As described above, the hub of the digital entertainment product 102 includes a smart card storing thereon a private key, while the exterior portion of the digital entertainment product 102 stores encrypted digital entertainment content in a read-only format. The smart card reader 202 obtains a decryption key generated from a public key and the private key. For instance, the public key may be stored on the digital entertainment product as described above, or may be obtained by the smart card or on behalf of the smart card by the player from a server via the Internet (or other source external to the digital entertainment product). More specifically, the decryption key can be generated by the smart card using the private key and the public key. The player includes hardware and/or software configured to decrypt encrypted digital entertainment content. The player 202 may then decrypt the encrypted digital entertainment content using the decryption key.

While information such as a public key may be obtained locally, the public key may also be obtained from an external source such as a server via the Internet. FIG. 3 is a diagram illustrating a client-server embodiment in which an external server provides information such as a public key to enable the entertainment content stored on the digital entertainment product to be decrypted in accordance with various embodiments of the invention. As shown in FIG. 3, a player 202 such as that described above with reference to FIG. 2 accepts a digital entertainment product such as that described above with reference to FIG. 1. In order to play the content stored on the digital entertainment product, a public key is obtained via Internet 302 via a server 304. A decryption key is generated via the smart card or the player, and the encrypted digital content is decrypted and played by the player 202.

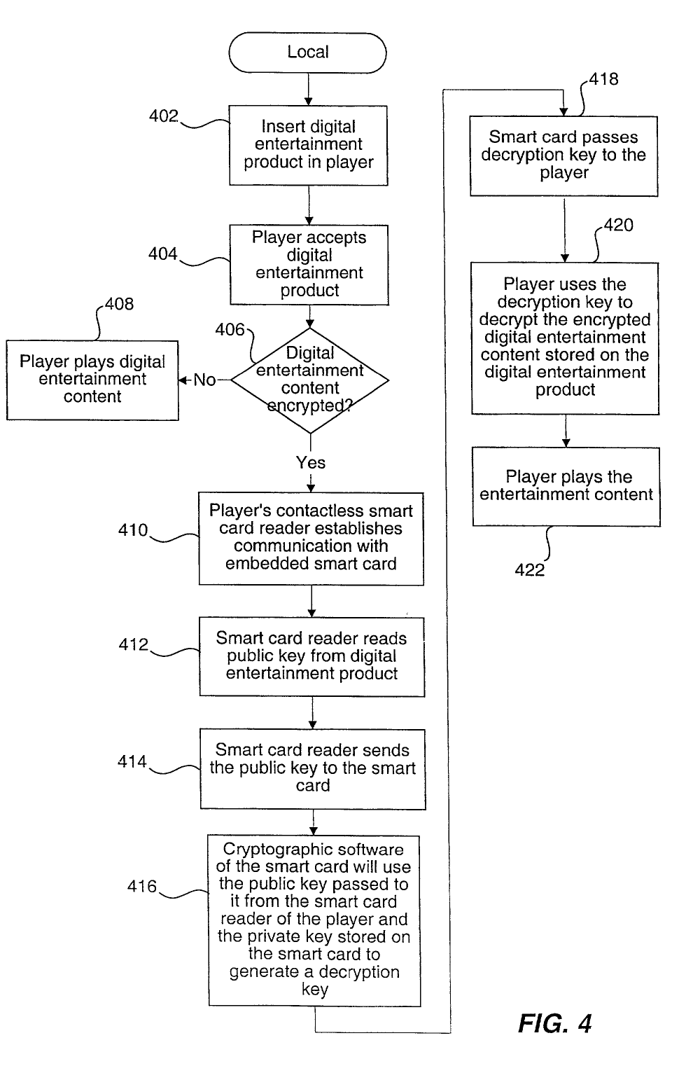

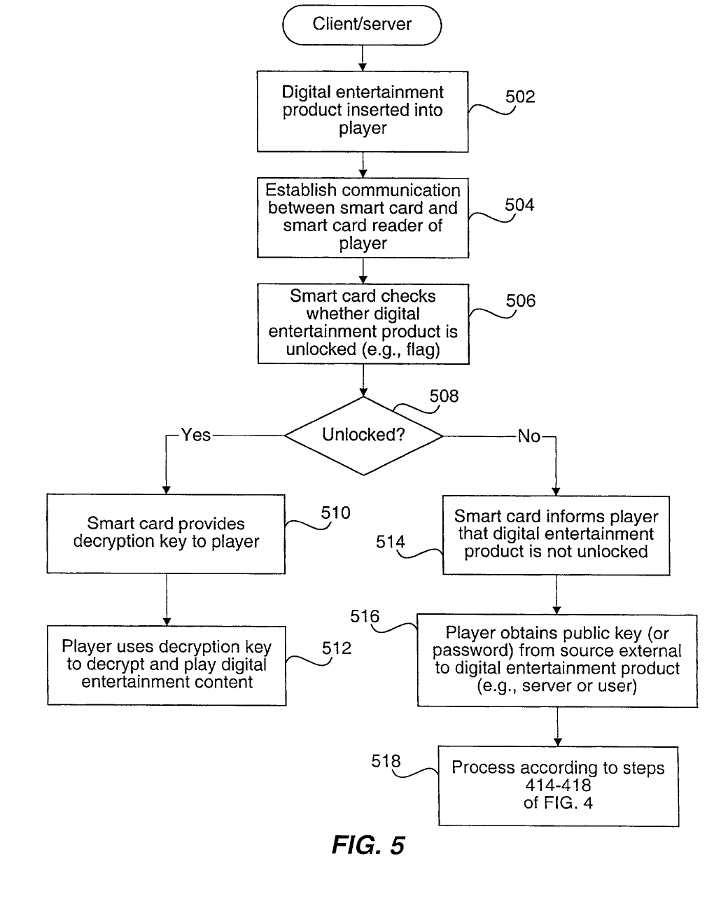

FIG. 4 is a process flow diagram illustrating a method of decrypting digital entertainment content using a public key stored on the digital entertainment product in accordance with various embodiments of the invention. At block 402 the digital entertainment product is inserted into a player such as a CD or DVD player. The player accepts the digital entertainment product at block 404. The player may assume that the digital entertainment is encrypted. Alternatively, as shown at block 406, the player determines whether the digital entertainment content is encrypted. If the digital entertainment content is not encrypted, the player plays the digital entertainment content at block 408.

If the digital entertainment content is encrypted, the player's smart card reader (e.g., contactless smart card reader) establishes communication with the embedded smart card at block 410. The smart card reader reads the public key from the digital entertainment product at block 412 and sends the public key to the smart card at block 414. Cryptographic software and/or hardware of the smart card use the public key passed to it from the smart card reader of the player and the private key stored on the smart card to generate a decryption key at block 416. The smart card passes the decryption key to the player at block 418. The player then uses the decryption key to decrypt the encrypted digital entertainment content stored on the digital entertainment product at block 420. The player then plays the digital entertainment content at block 422. In this manner, a digital entertainment product may be authenticated each time the content stored on that disk is played.

FIG. 5 is a process flow diagram illustrating a method of decrypting digital entertainment content using a public key and/or password obtained from a source external to the digital entertainment product in accordance with various embodiments of the invention. As shown at block 502, the digital entertainment product is inserted into a player. Communication is then established between the smart card and the smart card reader of the player at block 504. It is then determined from the smart card whether the digital entertainment content can be played at block 506. For instance, a data structure such as a flag or other mechanism stored on the smart card may be checked to determine whether the content is “unlocked” or otherwise available for access. In other words, the content may be “permanently” unlocked as well as “temporarily” unlocked on a per-use basis. For instance, once decrypted, the content and/or decryption key may be stored for subsequent access by a smart card reader.

If the content is determined to be unlocked at block 508, the smart card provides the decryption key to the player at block 510 and the player uses the decryption key to decrypt and play the digital entertainment content at block 512. However, if the content is not unlocked, the smart card may inform the player that digital entertainment content is not unlocked as shown at block 514. The player then obtains a public key (and/or password) from a source external to the digital entertainment product at block 516. For instance, the public key and/or password may be obtained from a user via a data entry mechanism such as a keyboard. Alternatively, the public key and/or password may be obtained from a server via the Internet.

Once the public key and/or password are obtained, the player plays the digital entertainment content at block 518 as described above with respect to steps 414-418. More specifically, the smart card reader sends the public key to the smart card at block 414. Cryptographic software and/or hardware of the smart card use the public key passed to it from the smart card reader of the player and the private key stored on the smart card to generate a decryption key at block 416. The smart card passes the decryption key to the player at block 418, thereby enabling the player to play the decrypted content.

Multiple private keys may be stored on the digital entertainment product in association with different content stored on the digital medium. For instance, this may be desirable when multiple types of content (e.g., videos, movies, games), versions (e.g., different movie endings), or ratings (e.g., PG, R) are stored on a single digital medium. Thus, a different decryption key will be generated corresponding to each of the private keys.

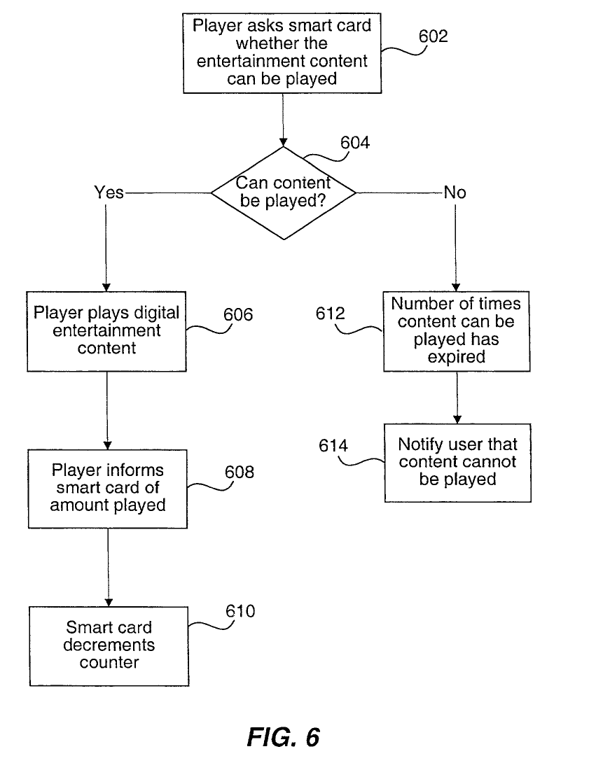

In accordance with the local or client-server implementations, it may be desirable to enable content stored on a digital medium to be played a specified number of times. FIG. 6 is a process flow diagram illustrating a method of tracking a number of times the content can be played in accordance with various embodiments of the invention. For instance, this may be desirable to enable a user to watch a movie stored on a digital medium a specified number of times. Thus, the smart card is configured for enabling the digital entertainment content to be played a specified number of times. For instance, this number of times may be a specified number, or may be ascertained from other information stored on the smart card. As described above with reference to FIG. 4 and FIG. 5, a player determines from the smart card whether the entertainment content can be played at block 602. As shown at block 604, if it is determined that the content can be played, the player plays the digital entertainment content at block 606. The player then informs the smart card of the amount played at block 608. The smart card then decrements (or increments) a counter as appropriate at block 610. If it is determined that the content cannot be played, the number of times the content can be played has expired as shown at block 612. The user may then be notified that the content cannot be played, as shown at block 614.

In addition to or instead of the above-described embodiments, alternative types of information may be used to secure information stored on a digital entertainment product. For instance, user data such as a password or identity of the owner of the disk be accessed to determine whether the digital entertainment content may be accessed and played. As another example, user preferences related to the software on the digital entertainment medium may be accessed to determine whether the digital entertainment content may be played. For instance, the user preferences may indicate a game score. Thus, in this example, the player of a video game may continue to play another round when the game score is above a specified score.

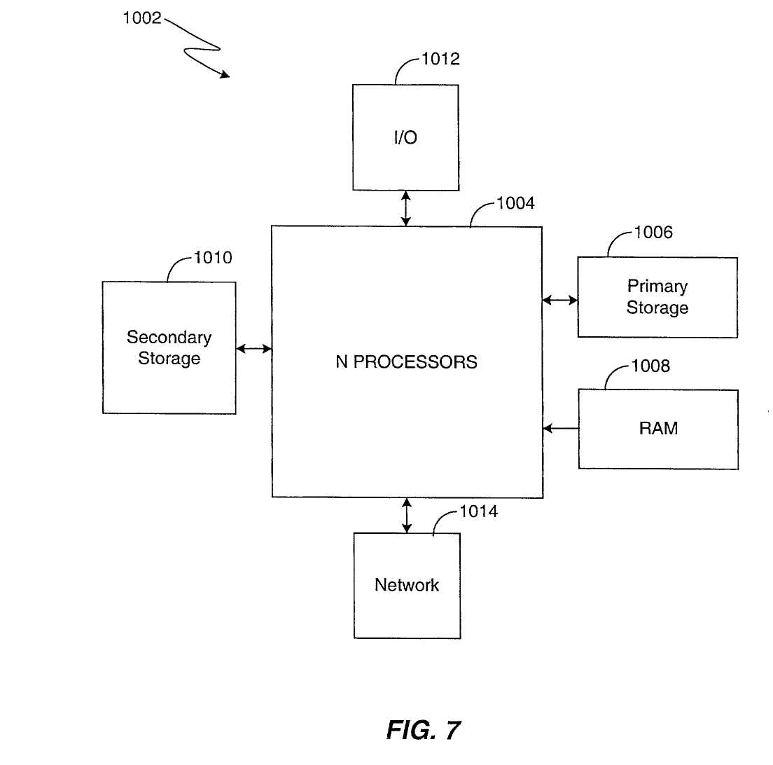

The present invention may be implemented on any suitable computer system. FIG. 7 illustrates a typical, general-purpose computer system 1002 suitable for implementing the present invention. The computer system may take any suitable form. For example, the computer system may be integrated with a digital television receiver or set top box.

Computer system 1030 or, more specifically, CPUs 1032, may be arranged to support a virtual machine, as will be appreciated by those skilled in the art. The computer system 1002 includes any number of processors 1004 (also referred to as central processing units, or CPUs) that may be coupled to memory devices including primary storage device 1006 (typically a read only memory, or ROM) and primary storage device 1008 (typically a random access memory, or RAM). As is well known in the art, ROM acts to transfer data and instructions uni-directionally to the CPUs 1004, while RAM is used typically to transfer data and instructions in a bi-directional manner. Both the primary storage devices 1006, 1008 may include any suitable computer-readable media. The CPUs 1004 may generally include any number of processors.

A secondary storage medium 1010, which is typically a mass memory device, may also be coupled bi-directionally to CPUs 1004 and provides additional data storage capacity. The mass memory device 1010 is a computer-readable medium that may be used to store programs including computer code, data, and the like. Typically, the mass memory device 1010 is a storage medium such as a hard disk which is generally slower than primary storage devices 1006, 1008.

The CPUs 1004 may also be coupled to one or more input/output devices 1012 that may include, but are not limited to, devices such as video monitors, track balls, mice, keyboards, microphones, touch-sensitive displays, transducer card readers, magnetic or paper tape readers, tablets, styluses, voice or handwriting recognizers, or other well-known input devices such as, of course, other computers. Finally, the CPUs 1004 optionally may be coupled to a computer or telecommunications network, e.g., an internet network or an intranet network, using a network connection as shown generally at 1014. With such a network connection, it is contemplated that the CPUs 1004 might receive information from the network, or might output information to the network in the course of performing the above-described method steps. Such information, which is often represented as a sequence of instructions to be executed using the CPUs 1004, may be received from and outputted to the network, for example, in the form of a computer data signal embodied in a carrier wave.

Although illustrative embodiments and applications of this invention are shown and described herein, many variations and modifications are possible which remain within the concept, scope, and spirit of the invention, and these variations would become clear to those of ordinary skill in the art after perusal of this application. For instance, although public key encryption is disclosed as an encryption mechanism, other types of encryption mechanisms may be used. For instance, a certificate, digital key or other mechanism may be used to securely store digital entertainment content or other digital content on a digital medium. As another example, a key or certificate stored on the smart card may be tied to information such as a serial number of an individual player device. Thus, a private key as well as a public key may differ for two digital mediums, even where they store identical digital content. Moreover, the above described process blocks are illustrative only. For instance, although the above-described process steps refer to a public key, the appropriate steps may also be performed with respect to the associated certificate. Therefore, the above-described process steps may be performed simultaneously as well as in an alternate order. Accordingly, the present embodiments are to be considered as illustrative and not restrictive, and the invention is not to be limited to the details given herein, but may be modified within the scope and equivalents of the appended claims.

What is claimed is:

1. A digital entertainment product stored on a digital media, comprising:
a hub including a smart card storing thereon a private key; and
an exterior portion of the digital entertainment product surrounding the hub, the exterior portion storing encrypted digital entertainment content in a read-only format;
wherein the smart card is adapted for accessing a public key and for generating a decryption key from the private key and the public key for decrypting the encrypted digital entertainment content.

2. The digital entertainment product as recited in claim 1, wherein the digital media is a CD or DVD.

3. The digital entertainment product as recited in claim 1, wherein the smart card is a contactless smart card.

4. The digital entertainment product as recited in claim 1, wherein the public key is stored on the smart card.

5. The digital entertainment product as recited in claim 1, wherein the public key is stored on the exterior portion of the digital entertainment product.

6. The digital entertainment product as recited in claim 1, wherein the public key is stored on a server, wherein the smart card is adapted for accessing the public key from the server via the Internet.

7. The digital entertainment product as recited in claim 1, wherein the entertainment content comprises audio content.

8. The digital entertainment product as recited in claim 1, wherein the entertainment content comprises video content.

9. The digital entertainment product as recited in claim 1, wherein the smart card is adapted for enabling the digital entertainment content to be played a specified number of times.

10. A method of processing information stored on a digital entertainment product stored on a digital media, comprising:
receiving the digital entertainment product, the digital entertainment product having an hub and an exterior portion surrounding the hub, the hub including a smart card storing thereon a private key and the exterior portion storing encrypted digital entertainment content in a read-only format;
obtaining a decryption key generated from the private key from the smart card and a public key; and
decrypting the encrypted digital entertainment content using the decryption key.

11. The method as recited in claim 10, wherein the smart card stores thereon a second private key and the exterior portion stores a second encrypted digital entertainment content in a read-only format, the method further comprising:
obtaining a second decryption key generated from the second private key from the smart card and the public key; and
decrypting the second encrypted digital entertainment content using the second decryption key.

12. The method as recited in claim 10, wherein the private key is associated with a device adapted for playing the digital entertainment content.

13. The method as recited in claim 12, wherein the private key is associated with a serial number of the device.

14. The method as recited in claim 10, further comprising:
storing at least one of the decryption key and the decrypted digital entertainment content on the smart card.

15. The method as recited in claim 10, further comprising;
providing the public key to the smart card.

16. The method of claim 10, further comprising:
determining whether content stored on the digital entertainment product is encrypted prior to obtaining the decryption key and decrypting the encrypted digital entertainment content.

17. The method as recited in claim 10, further comprising:
obtaining the public key from the digital entertainment product.

18. The method as recited in claim 17, further comprising:
obtaining the public key from the exterior portion of the digital entertainment product.

19. The method as recited in claim 17, further comprising:
obtaining the public key from the smart card of the digital entertainment product.

20. The method as recited in claim 10, further comprising:
obtaining the public key from a source external to the digital entertainment product.

21. The method as recited in claim 10, further comprising:
obtaining the public key from a server via the Internet.

22. The method as recited in claim 10, wherein the digital media is a CD or DVD.

23. The method as recited in claim 10, wherein the smart card is a contactless smart card.

24. The method as recited in claim 10, wherein the entertainment content comprises at least one of audio content and video content.

25. The method as recited in claim 10, further comprising:
determining from the smart card whether the digital entertainment content can be played.

26. The method as recited in claim 25, further comprising:
determining from a counter whether the digital entertainment content can be played;
playing the digital entertainment content; and
decrementing or incrementing the counter when the digital entertainment content is played.

27. The method as recited in claim 10, wherein the encrypted digital entertainment content comprises I frames.

28. The method as recited in claim 27, wherein the encrypted digital entertainment content does not comprise B or P frames.

29. The method as recited in claim 10, wherein the smart card further comprises at least one of user data identifying a user of the digital entertainment product and user preferences associated with the entertainment content, the method further comprising:
determining whether the digital entertainment content can be played from at least one of the user data and the user preferences.

30. The method as recited in claim 29, wherein the user data comprises a password.

31. The method as recited in claim 29, wherein the user data indicates an identity of an owner of the digital entertainment product.

32. The method as recited in claim 29, wherein the user preferences comprise preferences associated with the digital entertainment content.

33. The method as recited in claim 29, wherein the user preferences indicate a game score.

34. A digital entertainment product stored on a digital media, comprising:
a hub including a smart card storing thereon a key or certificate; and
an exterior portion of the digital entertainment product surrounding the hub, the exterior portion storing encrypted digital entertainment content in a read-only format;
wherein the smart card is adapted for accessing the key or certificate for use in decrypting the encrypted digital entertainment content.
a public key and for generating a decryption key from the private key and the public key for decrypting the encrypted digital entertainment content.

35. A method of processing information stored on a digital entertainment product stored on a digital media, comprising:
receiving the digital entertainment product, the digital entertainment product having an hub and an exterior portion surrounding the hub, the hub including a smart card storing thereon a key or certificate and the exterior portion storing encrypted digital entertainment content in a read-only format;
obtaining the key or certificate; and
decrypting the encrypted digital entertainment content using the key or certificate.

36. The method as recited in claim 35, further comprising:
obtaining a decryption key generated from the key or certificate;
decrypting the encrypted digital entertainment content using the decryption key.

37. A computer-program product comprising a computer-readable medium storing thereon computer-readable instructions for processing information stored on a digital entertainment product stored on a digital media, comprising:
instructions for receiving the digital entertainment product, the digital entertainment product having an hub and an exterior portion surrounding the hub, the hub including a smart card storing thereon a private key and the exterior portion storing encrypted digital entertainment content in a read-only format;
instructions for obtaining a decryption key generated from the private key from the smart card and a public key; and
instructions for decrypting the encrypted digital entertainment content using the decryption key.

38. An apparatus for processing information stored on a digital entertainment product stored on a digital media, comprising:
a processor; and
a memory, at least one of the processor and the memory being adapted for:
receiving the digital entertainment product, the digital entertainment product having an hub and an exterior portion surrounding the hub, the hub including a smart card storing thereon a private key and the exterior portion storing encrypted digital entertainment content in a read-only format;
obtaining a decryption key generated from the private key from the smart card and a public key; and
decrypting the encrypted digital entertainment content using the decryption key.

39. An apparatus for processing information stored on a digital entertainment product stored on a digital media, comprising:
means for receiving the digital entertainment product, the digital entertainment product having an hub and an exterior portion surrounding the hub, the hub including a smart card storing thereon a private key and the exterior portion storing encrypted digital entertainment content in a read-only format;
means for obtaining a decryption key generated from the private key from the smart card and a public key; and
means for decrypting the encrypted digital entertainment content using the decryption key.

40. A computer-program product comprising a computer-readable medium storing thereon computer-readable instructions for processing information stored on a digital entertainment product stored on a digital media, comprising:
instructions for receiving the digital entertainment product, the digital entertainment product having an hub and an exterior portion surrounding the hub, the hub including a smart card storing thereon a key or certificate and the exterior portion storing encrypted digital entertainment content in a read-only format;
instructions for obtaining the key or certificate; and
instructions for decrypting the encrypted digital entertainment content using the key or certificate.

41. An apparatus for processing information stored on a digital entertainment product stored on a digital media, comprising:
a processor; and
a memory, at least one of the processor and the memory being adapted for:
receiving the digital entertainment product, the digital entertainment product having an hub and an exterior portion surrounding the hub, the hub including a smart card storing thereon a key or certificate and the exterior portion storing encrypted digital entertainment content in a read-only format;
obtaining the key or certificate; and
decrypting the encrypted digital entertainment content using the key or certificate.

42. An apparatus for processing information stored on a digital entertainment product stored on a digital media, comprising:
means for receiving the digital entertainment product, the digital entertainment product having an hub and an exterior portion surrounding the hub, the hub including a smart card storing thereon a key or certificate and the exterior portion storing encrypted digital entertainment content in a read-only format;
means for obtaining the key or certificate; and
means for decrypting the encrypted digital entertainment content using the key or certificate.
